(19) United States
(12) Patent Application Publication
(10) Pub. No.: US 2023/0260025 A1
(43) Pub. Date: Aug. 17, 2023

(54) SYSTEM AND METHOD FOR FACILITATING HIGH FREQUENCY PROCESSING USING STORED MODELS

(71) Applicant: BANK OF AMERICA CORPORATION, Charlotte, NC (US)

(72) Inventors: Nitin Saraswat, Haryana (IN); Manish Mohan, Uttar Pradesh (IN); Rishi Jhamb, Haryana (IN)

(73) Assignee: BANK OF AMERICA CORPORATION, Charlotte, NC (US)

(21) Appl. No.: 17/671,079

(22) Filed: Feb. 14, 2022

(51) Int. Cl. G06Q 40/04; G06N 20/20

(52) U.S. Cl. CPC G06Q 40/04; G06N 20/20

(57) ABSTRACT

Systems, methods, and computer program products are provided for facilitating high frequency processing using stored models. A method for facilitating high frequency processing using stored models is provided. The method includes receiving a set of code relating to a machine learning model configured to process data. The method also includes generating a model executable file from the set of code relating to the machine learning model. The model executable file is configured to process inputted data using the machine learning model upon execution. The method still further includes storing the model executable file on an in-memory of a local device used to process inputted data.

### TECHNOLOGICAL FIELD

An example embodiment relates generally to machine learning model processing, and more particularly, to facilitating high frequency processing using stored models.

### BACKGROUND

High frequency processing relies on low latency in all aspects of processing. Therefore, the faster applications can be processed, the better result. Today, it can be difficult to facilitate high frequency processing with current limitations. Therefore, there exists a need for a system to facilitate high frequency processing.

### BRIEF SUMMARY

The following presents a summary of certain embodiments of the disclosure. This summary is not intended to identify key or critical elements of all embodiments nor delineate the scope of any or all embodiments. Its sole purpose is to present certain concepts and elements of one or more embodiments in a summary form as a prelude to the more detailed description that follows.

In an example embodiment, a system for facilitating high frequency processing using stored models is provided. The system includes at least one non-transitory storage device and at least one processing device coupled to the at least one non-transitory storage device. The at least one processing device is configured to receive a set of code relating to a machine learning model configured to process data. The at least one processing device is also configured to generate a model executable file from the set of code relating to the machine learning model. The model executable file is configured to process inputted data using the machine learning model upon execution. The at least one processing device is further configured to store the model executable file on an in-memory of a local device used to process inputted data.

In some embodiments, the at least one processing device is further configured to cause an execution of the model executable file on the in-memory of the local device. In some embodiments, the at least one processing device is further configured to determine a processing decision based at least in part on an output of the model executable file.

In some embodiments, the at least one processing device is further configured to create one or more additional model executable files based on a set of code of one or more additional machine learning models. In some embodiments, the at least one processing device is further configured to determine a processing decision based at least in part on an output of the model executable file and at least one of one or more additional outputs from the one or more additional model executable files.

In some embodiments, the inputted data is streaming data received from a plurality of sources. In such an embodiment, the model executable file is configured to process the inputted data from the plurality of sources and the system is capable of executing the model executable file simultaneously for two sets of inputted data. In some embodiments, a plurality of model executable file is stored for a plurality of machine learning models with each of the plurality of executable files being stored on the in-memory of the local device.

In another example embodiment, a computer program product for facilitating high frequency processing using stored models is provided. The computer program product includes at least one non-transitory computer-readable medium having computer-readable program code portions embodied therein. The computer-readable program code portions include an executable portion configured to receive a set of code relating to a machine learning model configured to process data. The computer-readable program code portions also include an executable portion configured to generate a model executable file from the set of code relating to the machine learning model. The model executable file is configured to process inputted data using the machine learning model upon execution. The computer-readable program code portions further include an executable portion configured to store the model executable file on an in-memory of a local device used to process inputted data.

In some embodiments, the computer-readable program code portions include an executable portion configured to cause an execution of the model executable file on the in-memory of the local device. In some embodiments, the computer-readable program code portions include an executable portion configured to determine a processing decision based at least in part on an output of the model executable file.

In some embodiments, the computer-readable program code portions include an executable portion configured to create one or more additional model executable files based on a set of code of one or more additional machine learning models. In some embodiments, the computer-readable program code portions include an executable portion configured to determine a processing decision based at least in part on an output of the model executable file and at least one of one or more additional outputs from the one or more additional model executable files.

In some embodiments, the inputted data is streaming data received from a plurality of sources. In such an embodiment, the model executable file is configured to process the inputted data from the plurality of sources and the system is capable of executing the model executable file simultaneously for two sets of inputted data. In some embodiments, a plurality of model executable file is stored for a plurality of machine learning models with each of the plurality of executable files being stored on the in-memory of the local device.

In still another example embodiment, a computer-implemented method for facilitating high frequency processing using stored models is provided. The method includes receiving a set of code relating to a machine learning model configured to process data. The method also includes generating a model executable file from the set of code relating to the machine learning model. The model executable file is configured to process inputted data using the machine learning model upon execution. The method further includes storing the model executable file on an in-memory of a local device used to process inputted data.

In some embodiments, the method also includes causing an execution of the model executable file on the in-memory of the local device. In some embodiments, the method also includes determining a processing decision based at least in part on an output of the model executable file.

In some embodiments, the method also includes creating one or more additional model executable files based on a set of code of one or more additional machine learning models. In some embodiments, the method also includes determining a processing decision based at least in part on an output of the model executable file and at least one of one or more additional outputs from the one or more additional model executable files.

In some embodiments, the inputted data is streaming data received from a plurality of sources. In such an embodiment, the model executable file is configured to process the inputted data from the plurality of sources and the system is capable of executing the model executable file simultaneously for two sets of inputted data.

Embodiments of the present disclosure address the above needs and/or achieve other advantages by providing apparatuses (e.g., a system, computer program product and/or other devices) and methods for facilitating high frequency processing using stored models. The system embodiments may comprise one or more memory devices having computer readable program code stored thereon, a communication device, and one or more processing devices operatively coupled to the one or more memory devices, wherein the one or more processing devices are configured to execute the computer readable program code to carry out said embodiments. In computer program product embodiments of the disclosure, the computer program product comprises at least one non-transitory computer readable medium comprising computer readable instructions for carrying out said embodiments. Computer implemented method embodiments of the disclosure may comprise providing a computing system comprising a computer processing device and a non-transitory computer readable medium, where the computer readable medium comprises configured computer program instruction code, such that when said instruction code is operated by said computer processing device, said computer processing device performs certain operations to carry out said embodiments.

### BRIEF DESCRIPTION OF THE DRAWINGS

Having thus described embodiments of the disclosure in general terms, reference will now be made the accompanying drawings, wherein:

FIG. 1 provides a block diagram illustrating a system environment for facilitating high frequency processing using stored models, in accordance with embodiments of the present disclosure;

FIG. 2 provides a block diagram illustrating the entity system 200 of FIG. 1, in accordance with embodiments of the present disclosure;

FIG. 3 provides a block diagram illustrating a machine learning model engine device 300 of FIG. 1, in accordance with embodiments of the present disclosure;

FIG. 4 provides a block diagram illustrating the computing device system 400 of FIG. 1, in accordance with embodiments of the present disclosure; and

FIG. 5 provides a block diagram illustrating a high frequency trading model in accordance with embodiments of the present disclosure;

FIG. 6 illustrates the method of converting a machine learning model into an executable file, in accordance with embodiments of the present disclosure;

FIG. 7 provides a flowchart illustrating a method of facilitating high frequency processing using stored models, in accordance with embodiments of the present disclosure; and

FIG. 8 provides a block diagram illustrating the structure of an in-memory used in various embodiments of the present disclosure.

### DETAILED DESCRIPTION

Embodiments of the present disclosure will now be described more fully hereinafter with reference to the accompanying drawings, in which some, but not all, embodiments of the present disclosure are shown. Indeed, the present disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As described herein, the term “entity” may be any organization that utilizes one or more entity resources, including, but not limited to, one or more entity systems, one or more entity databases, one or more applications, one or more servers, or the like to perform one or more organization activities associated with the entity. In some embodiments, an entity may be any organization that develops, maintains, utilizes, and/or controls one or more applications and/or databases. Applications as described herein may be any software applications configured to perform one or more operations of the entity. Databases as described herein may be any datastores that store data associated with organizational activities associated with the entity. In some embodiments, the entity may be a financial institution which may include herein may include any financial institutions such as commercial banks, thrifts, federal and state savings banks, savings and loan associations, credit unions, investment companies, insurance companies and the like. In some embodiments, the financial institution may allow a customer to establish an account with the financial institution. In some embodiments, the entity may be a non-financial institution.

Many of the example embodiments and implementations described herein contemplate interactions engaged in by a user with a computing device and/or one or more communication devices and/or secondary communication devices. A “user”, as referenced herein, may refer to an entity or individual that has the ability and/or authorization to access and use one or more applications provided by the entity and/or the system of the present disclosure. Furthermore, as used herein, the term “user computing device” or “mobile device” may refer to mobile phones, computing devices, tablet computers, wearable devices, smart devices and/or any portable electronic device capable of receiving and/or storing data therein.

A “user interface” is any device or software that allows a user to input information, such as commands or data, into a device, or that allows the device to output information to the user. For example, the user interface includes a graphical user interface (GUI) or an interface to input computer-executable instructions that direct a processing device to carry out specific functions. The user interface typically employs certain input and output devices to inputted data received from a user or to output data to a user. These input and output devices may include a display, mouse, keyboard, button, touchpad, touch screen, microphone, speaker, LED, light, joystick, switch, buzzer, bell, and/or other user input/output device for communicating with one or more users.

As used herein, “machine learning algorithms” may refer to programs (math and logic) that are configured to self-adjust and perform better as they are exposed to more data. To this extent, machine learning algorithms are capable of adjusting their own parameters, given feedback on previous performance in making prediction about a dataset. Machine learning algorithms contemplated, described, and/or used herein include supervised learning (e.g., using logistic regression, using back propagation neural networks, using random forests, decision trees, etc.), unsupervised learning (e.g., using an Apriori algorithm, using K-means clustering), semi-supervised learning, reinforcement learning (e.g., using a Q-learning algorithm, using temporal difference learning), and/or any other suitable machine learning model type. Each of these types of machine learning algorithms can implement any of one or more of a regression algorithm (e.g., ordinary least squares, logistic regression, stepwise regression, multivariate adaptive regression splines, locally estimated scatterplot smoothing, etc.), an instance-based method (e.g., k-nearest neighbor, learning vector quantization, self-organizing map, etc.), a regularization method (e.g., ridge regression, least absolute shrinkage and selection operator, elastic net, etc.), a decision tree learning method (e.g., classification and regression tree, iterative dichotomiser 3, C4.5, chi-squared automatic interaction detection, decision stump, random forest, multivariate adaptive regression splines, gradient boosting machines, etc.), a Bayesian method (e.g., naïve Bayes, averaged one-dependence estimators, Bayesian belief network, etc.), a kernel method (e.g., a support vector machine, a radial basis function, etc.), a clustering method (e.g., k-means clustering, expectation maximization, etc.), an associated rule learning algorithm (e.g., an Apriori algorithm, an Eclat algorithm, etc.), an artificial neural network model (e.g., a Perceptron method, a back-propagation method, a Hopfield network method, a self-organizing map method, a learning vector quantization method, etc.), a deep learning algorithm (e.g., a restricted Boltzmann machine, a deep belief network method, a convolution network method, a stacked auto-encoder method, etc.), a dimensionality reduction method (e.g., principal component analysis, partial least squares regression, Sammon mapping, multidimensional scaling, projection pursuit, etc.), an ensemble method (e.g., boosting, bootstrapped aggregation, AdaBoost, stacked generalization, gradient boosting machine method, random forest method, etc.), and/or any suitable form of machine learning algorithm.

As used herein, “machine learning model” may refer to a mathematical model generated by machine learning algorithms based on sample data, known as training data, to make predictions or decisions without being explicitly programmed to do so. The machine learning model represents what was learned by the machine learning algorithm and represents the rules, numbers, and any other algorithm-specific data structures required to for classification

Little to no lag or bottlenecking is paramount for high frequency processing. As machine learning and processing has advanced, the amount of processing demand has also increased. The rise in processing demand can often result in higher levels of lag or bottlenecking due to various system restraints. For high frequency trades, a system must be capable of processing large scale inputted data to make inferences in order to efficiently make the best trades in real-time. The processing of the large scale inputted data includes model calibration and back testing of the inputted data. From the processing of the large scale inputted data, the system of various embodiments is capable of maintaining transaction level compliance, as well as manage hazard in real-time. Additionally, the system of various embodiments is capable of achieving these functions with a reduced computational demand over current techniques.

Various embodiments of the present disclosure provide a system for facilitating high frequency processing using stored models. The system uses local memory to store machine learning models. The machine learning models are stored as executable files. To do this, the machine learning models are interpreted using a programming interpreter (e.g., a C interpreter), which is capable of interpreting models in any programing language. For example, a machine learning model can be a JavaScript Object Notation (JSON). The JSON file includes model architecture, model weight, model compilation details, and/or development framework. The interpreter interprets the JSON file according to the target platform, creating an executable file of the machine learning model. The executable file may be stored on local memory for execution. Once the executable file is stored, any inputted data received can be input into the executable file and the model executable file can produce output (e.g., a prediction of the inputted data to determine any issues).

The present disclosure uses streaming inputted data pipelines to tackle bottlenecking of data processing. The streaming inputted data pipelines enable data locality by allowing machine learning model results to be computed on local memory. Saving machine learning models locally allows for multiple machine learning models to be used in parallel without unnecessary strain on the processor(s).

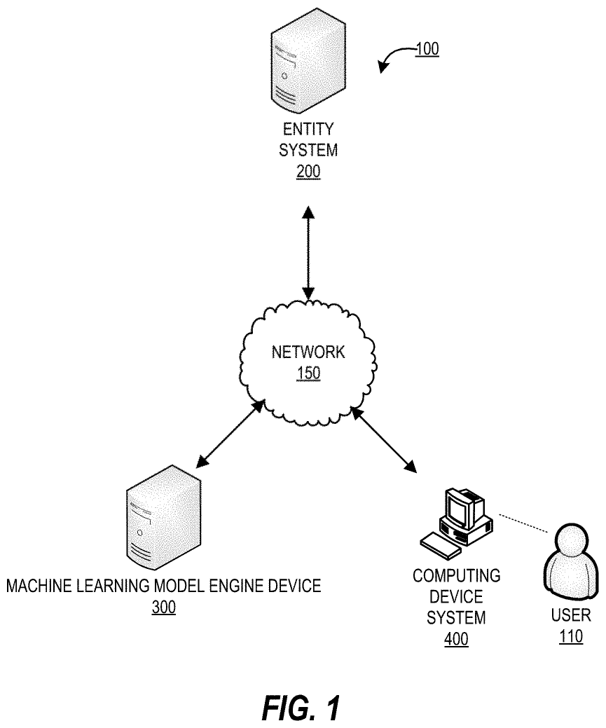

FIG. 1 provides a block diagram illustrating a system environment 100 for facilitating high frequency processing using stored models. As illustrated in FIG. 1, the environment 100 includes a machine learning model engine device 300, an entity system 200, and a computing device system 400. One or more users 110 may be included in the system environment 100, where the users 110 interact with the other entities of the system environment 100 via a user interface of the computing device system 400. In some embodiments, the one or more user(s) 110 of the system environment 100 may be employees (e.g., application developers, database administrators, application owners, application end users, business analysts, finance agents, or the like) of an entity associated with the entity system 200.

The entity system(s) 200 may be any system owned or otherwise controlled by an entity to support or perform one or more process steps described herein. In some embodiments, the entity is a financial institution. In some embodiments, the entity may be a non-financial institution. In some embodiments, the entity may be any organization that utilizes one or more entity resources to perform one or more organizational activities.

The machine learning model engine device 300 is a system of the present disclosure for performing one or more process steps described herein. In some embodiments, the machine learning model engine device 300 may be an independent system. In some embodiments, the machine learning model engine device 300 may be a part of the entity system 200. For example, the methods discussed herein may be carried out by the entity system 200, the machine learning model engine device 300, the computing device system 400, and/or a combination thereof.

The machine learning model engine device 300, the entity system 200, and/or the computing device system 400 may be in network communication across the system environment 100 through the network 150. The network 150 may include a local area network (LAN), a wide area network (WAN), and/or a global area network (GAN). The network 150 may provide for wireline, wireless, or a combination of wireline and wireless communication between devices in the network. In one embodiment, the network 150 includes the Internet. In general, the machine learning model engine device 300 is configured to communicate information or instructions with the entity system 200 and/or the computing device system 400 across the network 150. While the entity system 200, the machine learning model engine device 300, the computing device system 400, and server device(s) are illustrated as separate components communicating via network 150, one or more of the components discussed here may be carried out via the same system (e.g., a single system may include the entity system 200 and the machine learning model engine device 300).

The computing device system 400 may be a system owned or controlled by the entity of the entity system 200 and/or the user 110. As such, the computing device system 400 may be a computing device of the user 110. In general, the computing device system 400 communicates with the user 110 via a user interface of the computing device system 400, and in turn is configured to communicate information or instructions with the machine learning model engine device 300, and/or entity system 200 across the network 150.

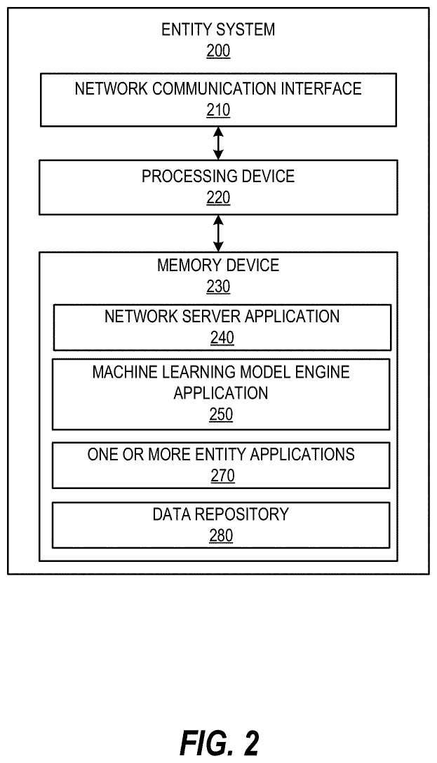

FIG. 2 provides a block diagram illustrating the entity system 200, in greater detail, in accordance with embodiments of the disclosure. As illustrated in FIG. 2, in one embodiment, the entity system 200 includes one or more processing devices 220 operatively coupled to a network communication interface 210 and a memory device 230. In certain embodiments, the entity system 200 is operated by a first entity, such as a financial institution. In some embodiments, the entity system 200 may be a multi-tenant cluster storage system.

It should be understood that the memory device 230 may include one or more databases or other data structures/repositories. The memory device 230 also includes computer-executable program code that instructs the processing device 220 to operate the network communication interface 210 to perform certain communication functions of the entity system 200 described herein. For example, in one embodiment of the entity system 200, the memory device 230 includes, but is not limited to, a machine learning model engine application 250, one or more entity applications 270, and a data repository 280 comprising data accessed, retrieved, and/or computed by the entity system 200. The one or more entity applications 270 may be any applications developed, supported, maintained, utilized, and/or controlled by the entity. The computer-executable program code of the network server application 240, the machine learning model engine application 250, the one or more entity application 270 to perform certain logic, data-extraction, and data-storing functions of the entity system 200 described herein, as well as communication functions of the entity system 200.

The network server application 240, the machine learning model engine application 250, and the one or more entity applications 270 are configured to store data in the data repository 280 or to use the data stored in the data repository 280 when communicating through the network communication interface 210 with the machine learning model engine device 300, and/or the computing device system 400 to perform one or more process steps described herein. In some embodiments, the entity system 200 may receive instructions from the machine learning model engine device 300 via the machine learning model engine application 250 to perform certain operations. The machine learning model engine application 250 may be provided by the machine learning model engine device 300. The one or more entity applications 270 may be any of the applications used, created, modified, facilitated, and/or managed by the entity system 200. The machine learning model engine application 250 may be in communication with the machine learning model engine device 300. In some embodiments, portions of the methods discussed herein may be carried out by the entity system 200.

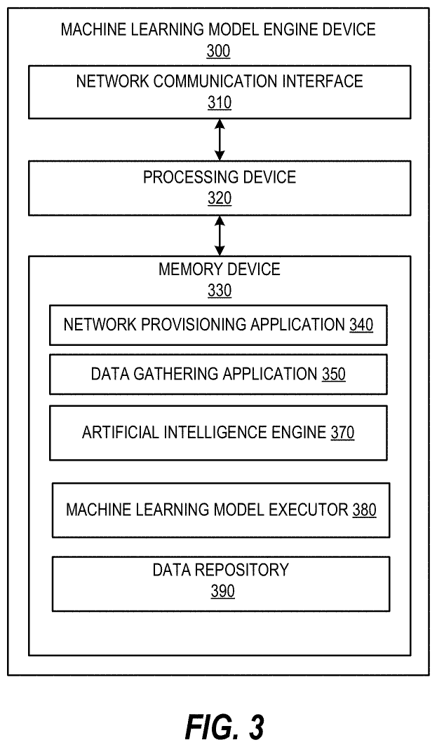

FIG. 3 provides a block diagram illustrating the machine learning model engine device 300 in greater detail, in accordance with various embodiments. As illustrated in FIG. 3, in one embodiment, the machine learning model engine device 300 includes one or more processing devices 320 operatively coupled to a network communication interface 310 and a memory device 330. In certain embodiments, the machine learning model engine device 300 is operated by an entity, such as a financial institution. In some embodiments, the machine learning model engine device 300 is owned or operated by the entity of the entity system 200. In some embodiments, the machine learning model engine device 300 may be an independent system. In alternate embodiments, the machine learning model engine device 300 may be a part of the entity system 200.

It should be understood that the memory device 330 may include one or more databases or other data structures/repositories. The memory device 330 also includes computer-executable program code that instructs the processing device 320 to operate the network communication interface 310 to perform certain communication functions of the machine learning model engine device 300 described herein. For example, in one embodiment of the machine learning model engine device 300, the memory device 330 includes, but is not limited to, a network provisioning application 340, a data gathering application 350, an artificial intelligence engine 370, a machine learning model executor 380, and a data repository 390 comprising any data processed or accessed by one or more applications in the memory device 330. The computer-executable program code of the network provisioning application 340, the data gathering application 350, the artificial intelligence engine 370, and the machine learning model executor 380 may instruct the processing device 320 to perform certain logic, data-processing, and data-storing functions of the machine learning model engine device 300 described herein, as well as communication functions of the machine learning model engine device 300.

The network provisioning application 340, the data gathering application 350, the artificial intelligence engine 370, and the machine learning model executor 380 are configured to invoke or use the data in the data repository 390 when communicating through the network communication interface 310 with the entity system 200, and/or the computing device system 400. In some embodiments, the network provisioning application 340, the data gathering application 350, the artificial intelligence engine 370, and the machine learning model executor 380 may store the data extracted or received from the entity system 200, and the computing device system 400 in the data repository 390. In some embodiments, the network provisioning application 340, the data gathering application 350, the artificial intelligence engine 370, and the machine learning model executor 380 may be a part of a single application.

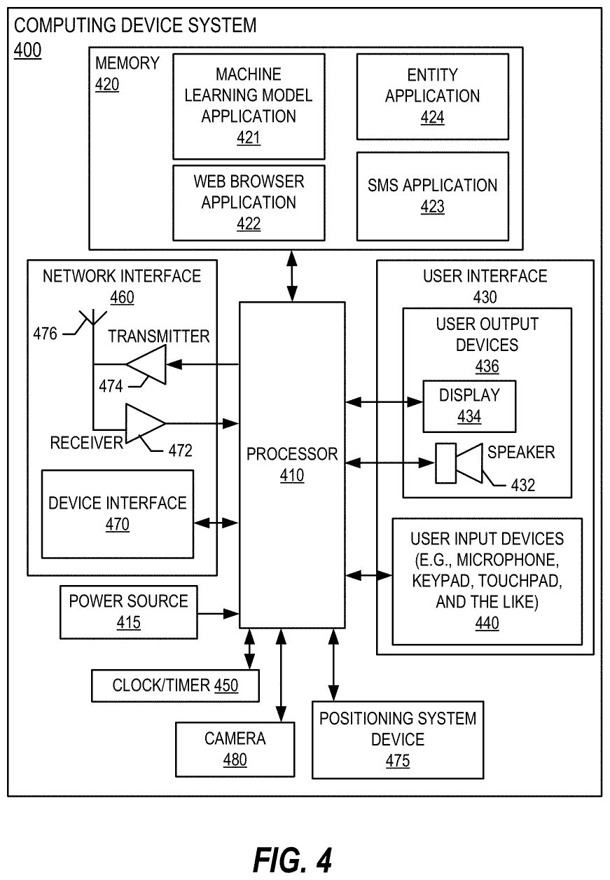

FIG. 4 provides a block diagram illustrating a computing device system 400 of FIG. 1 in more detail, in accordance with various embodiments. However, it should be understood that a mobile telephone is merely illustrative of one type of computing device system 400 that may benefit from, employ, or otherwise be involved with embodiments of the present disclosure and, therefore, should not be taken to limit the scope of embodiments of the present disclosure. Other types of computing devices may include portable digital assistants (PDAs), pagers, mobile televisions, electronic media devices, desktop computers, workstations, laptop computers, cameras, video recorders, audio/video player, radio, GPS devices, wearable devices, Internet-of-things devices, augmented reality devices, virtual reality devices, automated teller machine (ATM) devices, electronic kiosk devices, or any combination of the aforementioned.

Some embodiments of the computing device system 400 include a processor 410 communicably coupled to such devices as a memory 420, user output devices 436, user input devices 440, a network interface 460, a power source 415, a clock or other timer 450, a camera 480, and a positioning system device 475. The processor 410, and other processors described herein, generally include circuitry for implementing communication and/or logic functions of the computing device system 400. For example, the processor 410 may include a digital signal processor device, a microprocessor device, and various analog to digital converters, digital to analog converters, and/or other support circuits. Control and signal processing functions of the computing device system 400 are allocated between these devices according to their respective capabilities. The processor 410 thus may also include the functionality to encode and interleave messages and data prior to modulation and transmission. The processor 410 can additionally include an internal data modem. Further, the processor 410 may include functionality to operate one or more software programs, which may be stored in the memory 420. For example, the processor 410 may be capable of operating a connectivity program, such as a web browser application 422. The web browser application 422 may then allow the computing device system 400 to transmit and receive web content, such as, for example, location-based content and/or other web page content, according to a Wireless Application Protocol (WAP), Hypertext Transfer Protocol (HTTP), and/or the like.

The processor 410 is configured to use the network interface 460 to communicate with one or more other devices on the network 150. In this regard, the network interface 460 includes an antenna 476 operatively coupled to a transmitter 474 and a receiver 472 (together a “transceiver”). The processor 410 is configured to provide signals to and receive signals from the transmitter 474 and receiver 472, respectively. The signals may include signaling information in accordance with the air interface standard of the applicable cellular system of the wireless network 152. In this regard, the computing device system 400 may be configured to operate with one or more air interface standards, communication protocols, modulation types, and access types. By way of illustration, the computing device system 400 may be configured to operate in accordance with any of a number of first, second, third, and/or fourth-generation communication protocols and/or the like.

As described above, the computing device system 400 has a user interface that is, like other user interfaces described herein, made up of user output devices 436 and/or user input devices 440. The user output devices 436 include one or more displays 430 (e.g., a liquid crystal display or the like) and a speaker 432 or other audio device, which are operatively coupled to the processor 410.

The user input devices 440, which allow the computing device system 400 to receive data from a user such as the user 110, may include any of a number of devices allowing the computing device system 400 to receive data from the user 110, such as a keypad, keyboard, touch-screen, touchpad, microphone, mouse, joystick, other pointer device, button, soft key, and/or other input device(s). The user interface may also include a camera 480, such as a digital camera.

The computing device system 400 may also include a positioning system device 475 that is configured to be used by a positioning system to determine a location of the computing device system 400. For example, the positioning system device 475 may include a GPS transceiver. In some embodiments, the positioning system device 475 is at least partially made up of the antenna 476, transmitter 474, and receiver 472 described above. For example, in one embodiment, triangulation of cellular signals may be used to identify the approximate or exact geographical location of the computing device system 400. In other embodiments, the positioning system device 475 includes a proximity sensor or transmitter, such as an RFID tag, that can sense or be sensed by devices known to be located proximate a merchant or other location to determine that the computing device system 400 is located proximate these known devices.

The computing device system 400 further includes a power source 415, such as a battery, for powering various circuits and other devices that are used to operate the computing device system 400. Embodiments of the computing device system 400 may also include a clock or other timer 450 configured to determine and, in some cases, communicate actual or relative time to the processor 410 or one or more other devices.

The computing device system 400 also includes a memory 420 operatively coupled to the processor 410. As used herein, memory includes any computer readable medium (as defined herein below) configured to store data, code, or other information. The memory 420 may include volatile memory, such as volatile Random Access Memory (RAM) including a cache area for the temporary storage of data. The memory 420 may also include non-volatile memory, which can be embedded and/or may be removable. The non-volatile memory can additionally or alternatively include an electrically erasable programmable read-only memory (EEPROM), flash memory or the like.

The memory 420 can store any of a number of applications which comprise computer-executable instructions/code executed by the processor 410 to implement the functions of the computing device system 400 and/or one or more of the process/method steps described herein. For example, the memory 420 may include such applications as a conventional web browser application 422, a machine learning model application 421, entity application 424. These applications also typically instructions to a graphical user interface (GUI) on the display 430 that allows the user 110 to interact with the entity system 200, the machine learning model engine device 300, and/or other devices or systems. The memory 420 of the computing device system 400 may comprise a Short Message Service (SMS) application 423 configured to send, receive, and store data, information, communications, alerts, and the like via the wireless telephone network 152. In some embodiments, the machine learning model application 421 provided by the machine learning model engine device 300 allows the user 110 to access the machine learning model engine device 300. In some embodiments, the entity application 424 provided by the entity system 200 and the machine learning model application 421 allow the user 110 to access the functionalities provided by the machine learning model engine device 300 and the entity system 200.

The memory 420 can also store any of a number of pieces of information, and data, used by the computing device system 400 and the applications and devices that make up the computing device system 400 or are in communication with the computing device system 400 to implement the functions of the computing device system 400 and/or the other systems described herein.

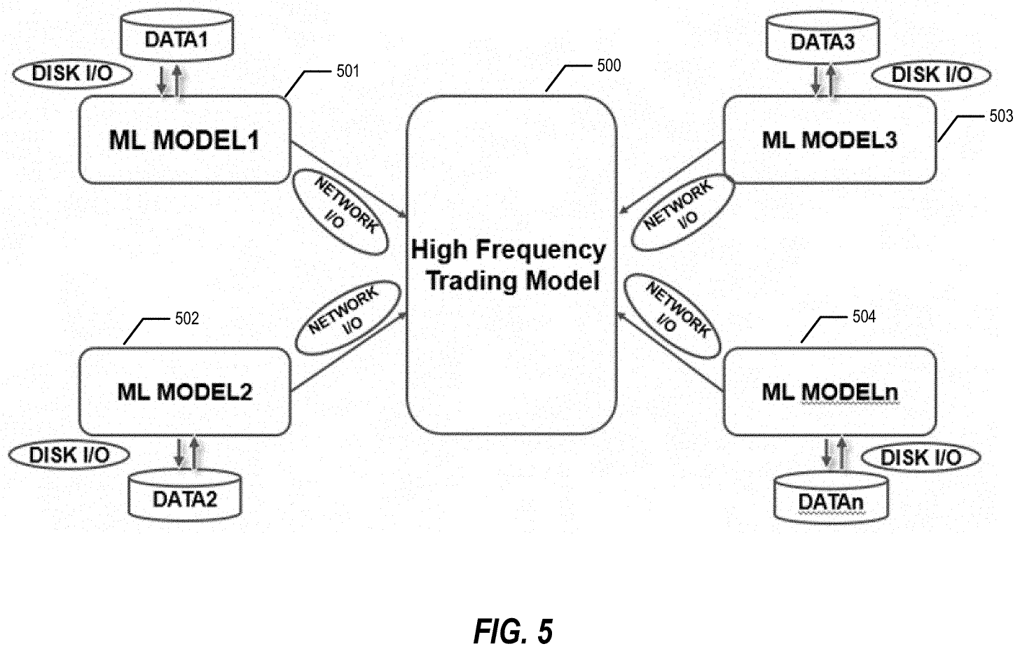

Referring now to FIG. 5, a high frequency trading model 500 may be in communication with a plurality of machine learning models (501-504) that each may provide different predictions or inferences relating to transaction stability and hazards. In an example embodiment, each of the machine learning models 501-504 may be stored in the local memory as individual executable files. The streaming inputted data may be processed by one or more of the executable files and used in the decision making of the high frequency trading model. As such, the processing can be automated, while limiting the processing demand.

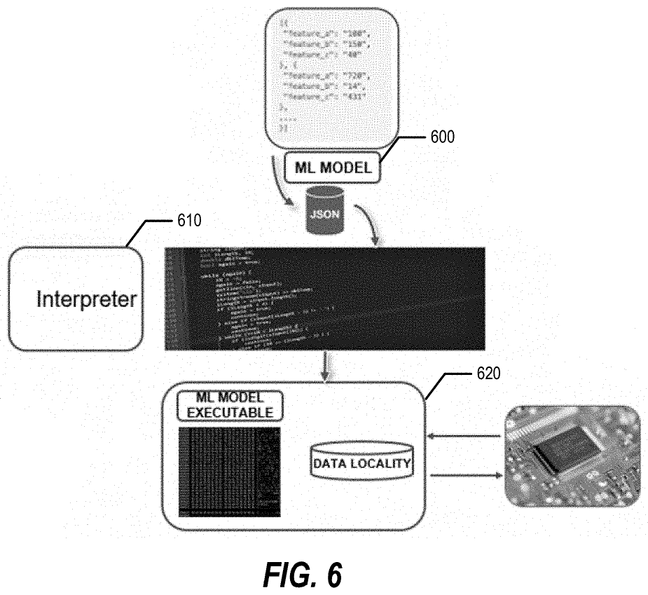

Referring now to FIG. 6, a flowchart illustrating the programming of a machine learning model is shown. As shown, the machine learning model 600 can be originally in the form of a JSON file. The JSON file is input into an interpreter 610 (e.g., a C interpreter). The interpreter 610 can interpret a plurality of programming languages and convert the code into an executable file. An executable file of the machine learning model is created upon being interpreted by the interpreter 610. The model executable file 620 can be stored, such as on local memory. Upon receiving streaming inputted data, the streaming inputted data can be processed by the executable file, creating an output of the analysis by the machine learning model. The analysis by the machine learning model may be a prediction of high frequency processing, including any hazards. Additionally, other types of machine learning models may be turned into executable files and stored locally using the operations discussed herein.

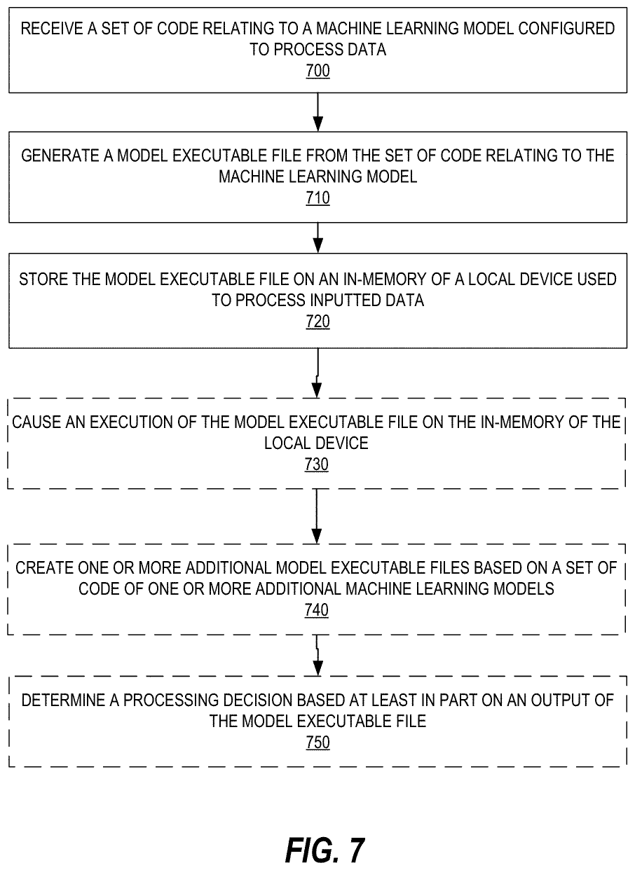

Referring now to FIG. 7, a method of facilitating high frequency processing using stored models is provided. The method may be carried out by a system discussed herein (e.g., the entity system 200, the machine learning model engine device 300, and/or the computing device system 400). An example system may include at least one non-transitory storage device and at least one processing device coupled to the at least one non-transitory storage device. In such an embodiment, the at least one processing device is configured to carry out the method discussed herein.

Referring now to Block 700 of FIG. 7, the method may include receiving a set of code relating to a machine learning model configured to process data. The code relating to the machine learning model may be in any computing language. The code may be capable of, when compiled processing inputted data to determine one or more prediction based on the data. The code itself may be created based on a machine learning algorithm. In some embodiments, the machine learning model be stored on the entity system 200 or otherwise under control of the entity. For example, a user of the entity may be the programmer of the machine learning model. The machine learning model may be provided by a third party.

Referring now to Block 710 of FIG. 7, the method may include generating a model executable file from the set of code relating to the machine learning model. The model executable file is configured to process inputted data using the machine learning model upon execution. The model executable file may be generated via an interpreter, such as a C interpreter. The code relating to the machine learning model may be inputted into the interpreter, which converts said code relating to the machine learning model into the model executable file. The interpreter may convert the machine learning model into a model executable file, such that the executable file, when executed can produce an output that is the same as the machine learning model.

Referring now to Block 720 of FIG. 7, the method may include storing the model executable file on an in-memory of a local device used to process inputted data. Upon generation of the model executable file, said executable file can be stored on any device or memory to be used in the future. In an example embodiment, the executable file can be stored on the in-memory of a local device. As such, the model executable file can be executed locally without unnecessary strain on the system side. Additionally, the model executable file can be used without having to compile the machine learning model each use. As such, the model executable file allows for a faster, more efficient analysis of inputted data.

The model executable file may also be transmitted to different devices, allowing individual devices to store and/or run the executable file. The format of the model executable file allows the machine learning model to be transmitted easily and then executed without requiring a compiler. The model executable file may also be stored on a remote device (e.g., the entity system 200 or the like).

Referring now to optional Block 730 of FIG. 7, the method may include causing an execution of the model executable file on the in-memory of the local device. As discussed above, the model executable file is configured to process inputted data through the given machine learning model. The model executable file, upon execution, is configured to output the analysis of the machine learning model. The analysis by the machine learning model may include a confidence value of the inputted data, a future prediction or inference (e.g., predicting a price based on the inputted data), and/or various other analysis values that are produced via a machine learning model. The model executable files are capable of producing any output that would be output by the machine learning model code set when compiled. As such, the model executable file is allowed to produce the same results while being stored on the in-memory and not needing a compiler to be executed.

The inputted data may be streaming data received from a plurality of sources. For example, streaming data may be continuously or near-continuously received by the system. The system may receive said streaming data from various third parties that track data. The inputted data may be analyzed for data integrity, as well as to make predictions that will assist in high frequency processing (e.g., high frequency trading). The inputted data may include, for example, financial data, processing data, transaction data, and/or the like. The system may be configured to execute the model executable file on a plurality of inputted data sets. In some instances, the system may be configured to execute the model executable file on a plurality of inputted data sets simultaneously.

Each model executable file may be configured to process one or more type of inputted data. For example, one model executable file may process financial data, while another model executable file may process other transaction data. While the machine learning models and subsequently the model executable files discussed herein are discussed in reference to high frequency trading, any machine learning models generated as a model executable file and be used in various different applications which use machine learning models currently.

Referring now to optional Block 740 of FIG. 7, the method may include creating one or more additional model executable files based on a set of code of one or more additional machine learning models. As discussed above, the operations may be used on multiple different sets of code for different machine learning models. In various embodiments, the system may use multiple machine learning models during analysis and, as such, each machine learning model may be stored as a model executable file. The system may use an interpreter (e.g., a C interpreter) that is configured to convert code in any programming language into an executable file. As machine learning has increased, many systems use multiple machine learning models to make processing more efficient. As such, the operations herein allow for multiple model executable files to be generated for multiple machine learning models.

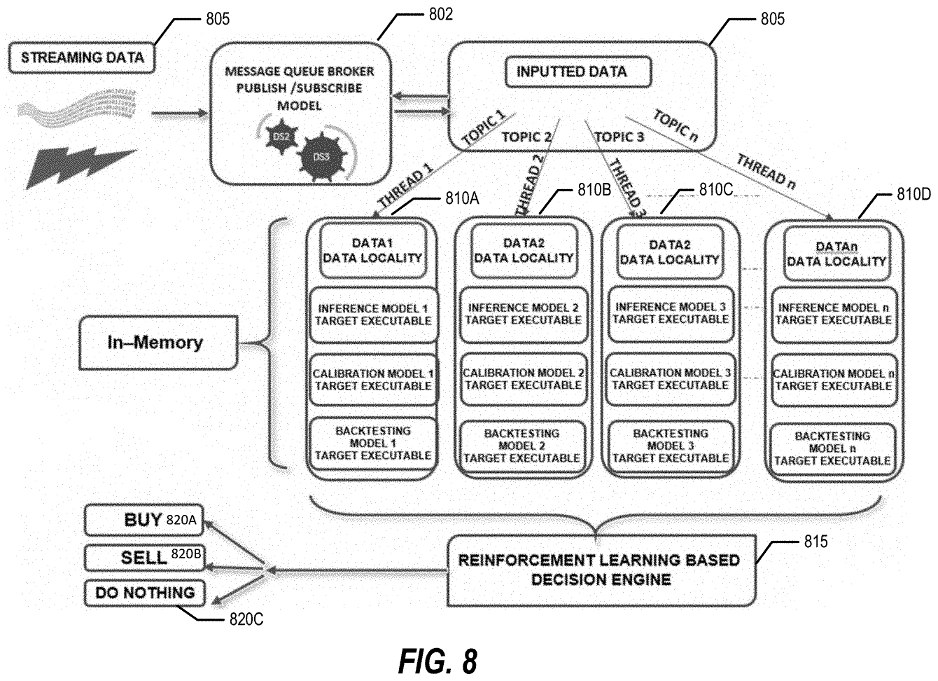

Referring now to optional Block 750 of FIG. 7, the method may include determining a processing decision based at least in part on an output of the model executable file. The processing decision may be whether to take an action. The processing decision may be based on one or more outputs of one or more model executable files. For example, in FIG. 8, the processing decision for an example embodiment for high frequency trading determines whether to buy, sell, or do nothing for a potential object. Multiple different machine learning models (e.g., multiple model executable files) may be used for a single processing decision. The processing decision may be completely automated, allowing for processing to be uninterpreted.

Referring now to FIG. 8, an example system architecture is shown using model executable files as discussed here to assist with high frequency trading. As discussed above, this use case is merely an example and the operations herein may be used with other machine learning model use cases.

In the example of FIG. 8, inputted data 805 (e.g., streaming data) is received by the system. The system may receive said inputted data from one or more sources. The inputted data may be raw data to be processed by one or more machine learning models. The inputted data may be pre-processed, such as through the message queue broker publish/subscribe model 802. The pre-processing may analyze the inputted data and prepare it for analysis by the machine learning models (e.g., confirming that the inputted data is in the correct format).

The in-memory of a local device (e.g., such as a computing device system 400) can be configured to store one or more model executable files. As show, the in-memory shown in FIG. 8 may have multiple threads (e.g., thread 1 810A, thread 2 810B, thread 3 810C, and thread n 810D) that each store different data locally. As shown, each thread has an inference model executable file, a calibration model executable file, and a back testing model executable file. The various model executable files may be the same across different threads (e.g., inference model 1 may be the same as inference model 2). Additionally or alternatively, some of the model executable files may be different across the threads (e.g., inference model 1 may not be the same as inference model 2). The individual thread allows for parallel processing by model executable files.

The inputted data may be processed by one or more threads and the outputs provided to the reinforcement learning based decision engine 815. The reinforcement learning based decision engine 815 may be part of the machine learning model engine device 300 and/or the entity system 200 of FIG. 1. The reinforcement learning based decision engine 815 may also be a machine learning model (and subsequently may also be a model executable file to be processed). In this example, where the system is used for high frequency trading. The reinforcement learning based decision engine 815 determines the processing decision, namely whether to execute a trade. For example, the reinforcement learning based decision engine 815 may use the outputs of one or more model executable files to determine whether to buy 820A, sell 820B, or do nothing 820C in reference to a given object. The model executable files allow for the determination process to be automated and efficient, allowing for the system to be used with high frequency trades that require near-real-time analysis.

As will be appreciated by one of skill in the art, the present disclosure may be embodied as a method (including, for example, a computer-implemented process, a business process, and/or any other process), apparatus (including, for example, a system, machine, device, computer program product, and/or the like), or a combination of the foregoing. Accordingly, embodiments of the present disclosure may take the form of an entirely hardware embodiment, an entirely software embodiment (including firmware, resident software, micro-code, and the like), or an embodiment combining software and hardware aspects that may generally be referred to herein as a “system.” Furthermore, embodiments of the present disclosure may take the form of a computer program product on a computer-readable medium having computer-executable program code embodied in the medium.

Any suitable transitory or non-transitory computer readable medium may be utilized. The computer readable medium may be, for example but not limited to, an electronic, magnetic, optical, electromagnetic, infrared, or semiconductor system, apparatus, or device. More specific examples of the computer readable medium include, but are not limited to, the following: an electrical connection having one or more wires; a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device.

In the context of this document, a computer readable medium may be any medium that can contain, store, communicate, or transport the program for use by or in connection with the instruction execution system, apparatus, or device. The computer usable program code may be transmitted using any appropriate medium, including but not limited to the Internet, wireline, optical fiber cable, radio frequency (RF) signals, or other mediums.

Computer-executable program code for carrying out operations of embodiments of the present disclosure may be written in an object oriented, scripted or unscripted programming language such as Java, Perl, Smalltalk, C++, or the like. However, the computer program code for carrying out operations of embodiments of the present disclosure may also be written in conventional procedural programming languages, such as the “C” programming language or similar programming languages.

Embodiments of the present disclosure are described above with reference to flowchart illustrations and/or block diagrams of methods, apparatus (systems), and computer program products. It will be understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks.

These computer-executable program code portions may also be stored in a computer-readable memory that can direct a computer or other programmable data processing apparatus to function in a particular manner, such that the code portions stored in the computer readable memory produce an article of manufacture including instruction mechanisms which implement the function/act specified in the flowchart and/or block diagram block(s).

The computer-executable program code may also be loaded onto a computer or other programmable data processing apparatus to cause a series of operational steps to be performed on the computer or other programmable apparatus to produce a computer-implemented process such that the code portions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the disclosure.

As the phrase is used herein, a processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

Embodiments of the present disclosure are described above with reference to flowcharts and/or block diagrams. It will be understood that steps of the processes described herein may be performed in orders different than those illustrated in the flowcharts. In other words, the processes represented by the blocks of a flowchart may, in some embodiments, be in performed in an order other that the order illustrated, may be combined or divided, or may be performed simultaneously. It will also be understood that the blocks of the block diagrams illustrated, in some embodiments, merely conceptual delineations between systems and one or more of the systems illustrated by a block in the block diagrams may be combined or share hardware and/or software with another one or more of the systems illustrated by a block in the block diagrams. Likewise, a device, system, apparatus, and/or the like may be made up of one or more devices, systems, apparatuses, and/or the like. For example, where a processor is illustrated or described herein, the processor may be made up of a plurality of microprocessors or other processing devices which may or may not be coupled to one another. Likewise, where a memory is illustrated or described herein, the memory may be made up of a plurality of memory devices which may or may not be coupled to one another.

While certain exemplary embodiments have been described and shown in the accompanying drawings, it is to be understood that such embodiments are merely illustrative of, and not restrictive on, the broad disclosure, and that this disclosure not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the disclosure. Therefore, it is to be understood that, within the scope of the appended claims, the disclosure may be practiced other than as specifically described herein.

What is claimed is:

1. A system for facilitating high frequency processing using stored models, the system comprising:
at least one non-transitory storage device; and
at least one processing device coupled to the at least one non-transitory storage device, wherein the at least one processing device is configured to:
receive a set of code relating to a machine learning model configured to process data,
generate a model executable file from the set of code relating to the machine learning model, wherein the model executable file is configured to process inputted data using the machine learning model upon execution; and
store the model executable file on an in-memory of a local device used to process inputted data.

2. The system of claim 1, wherein the at least one processing device is further configured to cause an execution of the model executable file on the in-memory of the local device, wherein the model executable file is configured to process the inputted data.

3. The system of claim 1, wherein the at least one processing device is further configured to determine a processing decision based at least in part on an output of the model executable file.

4. The system of claim 1, wherein the at least one processing device is further configured to create one or more additional model executable files based on a set of code of one or more additional machine learning models.

5. The system of claim 4, wherein the at least one processing device is further configured to determine a processing decision based at least in part on an output of the model executable file and at least one of one or more additional outputs from the one or more additional model executable files.

6. The system of claim 1, wherein the inputted data is streaming data received from a plurality of sources, wherein the model executable file is configured to process the inputted data from the plurality of sources, wherein the system is capable of executing the model executable file simultaneously for two sets of inputted data.

7. The system of claim 1, wherein a plurality of model executable file is stored for a plurality of machine learning models, wherein each of the plurality of executable files are stored on the in-memory of the local device.

8. A computer program product for facilitating high frequency processing using stored models, the computer program product comprising at least one non-transitory computer-readable medium having computer-readable program code portions embodied therein, the computer-readable program code portions comprising:
an executable portion configured to receive a set of code relating to a machine learning model configured to process data,
an executable portion configured to generate a model executable file from the set of code relating to the machine learning model, wherein the model executable file is configured to process inputted data using the machine learning model upon execution; and
an executable portion configured to store the model executable file on an in-memory of a local device used to process inputted data.

9. The computer program product of claim 8, wherein the computer-readable program code portions include an executable portion configured to cause an execution of the model executable file on the in-memory of the local device, wherein the model executable file is configured to process the inputted data.

10. The computer program product of claim 8, wherein the computer-readable program code portions include an executable portion configured to determine a processing decision based at least in part on an output of the model executable file.

11. The computer program product of claim 8, wherein the computer-readable program code portions include an executable portion configured to create one or more additional model executable files based on a set of code of one or more additional machine learning models.

12. The computer program product of claim 11, wherein the computer-readable program code portions include an executable portion configured to determine a processing decision based at least in part on an output of the model executable file and at least one of one or more additional outputs from the one or more additional model executable files.

13. The computer program product of claim 8, wherein the inputted data is streaming data received from a plurality of sources, wherein the model executable file is configured to process the inputted data from the plurality of sources, wherein the system is capable of executing the model executable file simultaneously for two sets of inputted data.

14. The computer program product of claim 8, wherein a plurality of model executable file is stored for a plurality of machine learning models, wherein each of the plurality of executable files are stored on the in-memory of the local device.

15. A computer-implemented method for facilitating high frequency processing using stored models, the method comprising:
receiving a set of code relating to a machine learning model configured to process data,
generating a model executable file from the set of code relating to the machine learning model, wherein the model executable file is configured to process inputted data using the machine learning model upon execution; and
storing the model executable file on an in-memory of a local device used to process inputted data.

16. The method of claim 15, further comprising causing an execution of the model executable file on the in-memory of the local device, wherein the model executable file is configured to process the inputted data.

17. The method of claim 15, further comprising determining a processing decision based at least in part on an output of the model executable file.

18. The method of claim 15, further comprising creating one or more additional model executable files based on a set of code of one or more additional machine learning models.

19. The method of claim 18, further comprising determining a processing decision based at least in part on an output of the model executable file and at least one of one or more additional outputs from the one or more additional model executable files.

20. The method of claim 15, wherein the inputted data is streaming data received from a plurality of sources, wherein the model executable file is configured to process the inputted data from the plurality of sources, wherein the system is capable of executing the model executable file simultaneously for two sets of inputted data.
